(19) United States
(12) Patent Application Publication
(10) Pub. No.: US 2004/0177070 A1
(43) Pub. Date: Sep. 9, 2004

(54) Planning system of cargo supply and transportation

(76) Inventors: Jui-Yi Lin, Taipei (TW); Jonathan Lin, Taipei (TW)

Correspondence Address: BIRCH STEWART KOLASCH & BIRCH, PO BOX 747, FALLS CHURCH, VA, 22040-0747, US

(21) Appl. No.: 10/377,709

(22) Filed: Mar. 4, 2003

(51) Int. Cl. G06F 17/30

(52) U.S. Cl. 707/6

(57) ABSTRACT

A planning system of cargo supply and transportation having a server and a client connected to the server optionally is disclosed such that the customer is able to transmit the desired service to the server via the client for the server to match the service the customer needs and the sever provides. Therefore, the service the server provides the service that best meets the customer's need.

### BACKGROUND OF THE INVENTION

1. Field of Invention

The invention relates to a planning system, more particular a planning goods supply and transshipment system for matching the services and the customer's needs, further the services and the servers providers.

2. Related Art

Shopping on the internet is becoming more prevalent. We can buy more things on internet than before. But when shopping on the internet, the customer has to accept the specific receiving place and the specific time that the internet shop provides. The receiving places are retail stores so the customers have to receive the goods in shop hours or in a specific period. This is very inconvenient for customers.

Moreover, when we shop on the internet, only one and the same distributor delivers the purchased cargo, so its no problem for him to ask a high delivery fee. After all, he has no competitors. If the service area the distributor provides is smaller, the customer outside the area could not purchase anything on the Internet. Besides, the distribution fee is not shared if there are two or more distributors with the same service.

A for matching the service required by the consumer and the service provided by the server such that the server provides the service that best meets the customer's need, and for solving the problems mentioned above is necessary.

### SUMMARY OF THE INVENTION

The main object of the invention is to provide a planning system of cargo supply and transportation for matching the service required by the consumer and the service provided by the server such that the server provides the service that best meets the customer's need.

The planning system of cargo supply and transportation of the invention has a server and a client. The server has a database and a matching processor. A supplier list and a distributor list are stored in the database. The supplier list has multiple cargo names and cargo fee corresponding to the cargo names. The distributor list has multiple distribution services, arrival time and distribution fee corresponding to each of the distribution services. The matching processor is connected to the database.

The client is connected to the server optionally and transmits the cargo demanded list to the matching processor of the server. The cargo demanded list has a cargo demand name, a receiving time, a receiving dock, and a fee. After the matching processor has received the cargo demanded list, the matching processor retrieves the distributor list and the supplier list from the database and matches the cargo demanded list, the supplier list, and the distributor list. Then a matching selection list is transmitted to the client for selecting and transmitted back to the server of assuring.

Further scope of applicability of the present invention will become apparent in the detailed description given below. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given below only, and doesn't limit the present invention:

FIG. 1 is a block diagram of the system of the invention.

FIG. 2 is a sketch map of the supplier list.

FIG. 3 is a sketch map of the distributor list.

FIG. 4 is a sketch map of the cargo demand list.

FIG. 5 is a sketch map the matching selection list.

### DETAILED DESCRIPTION OF THE INVENTION

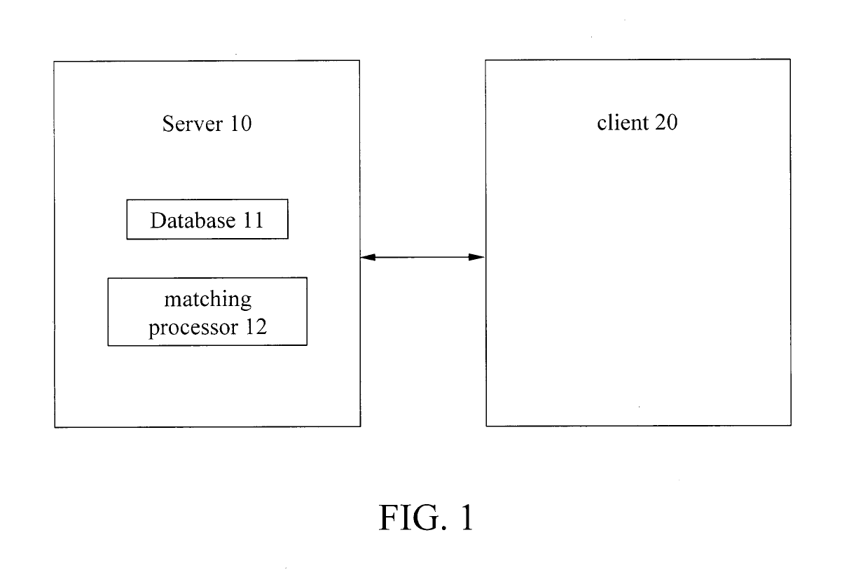

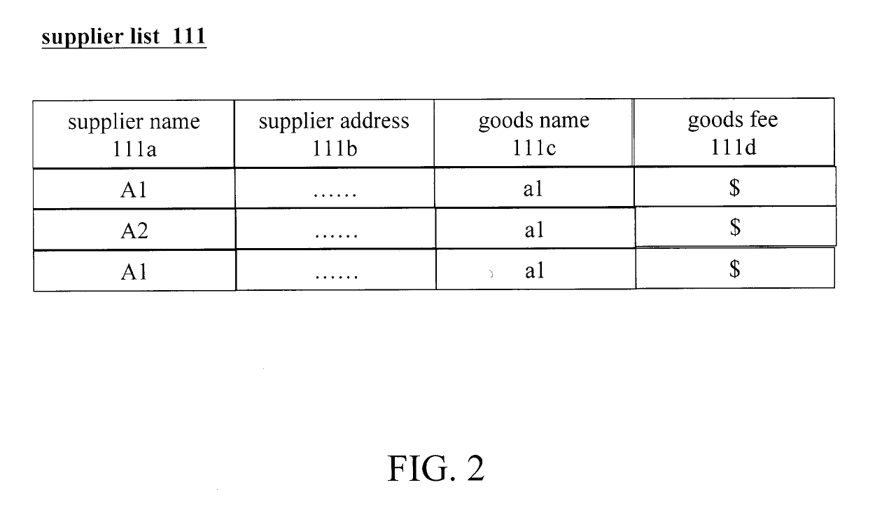

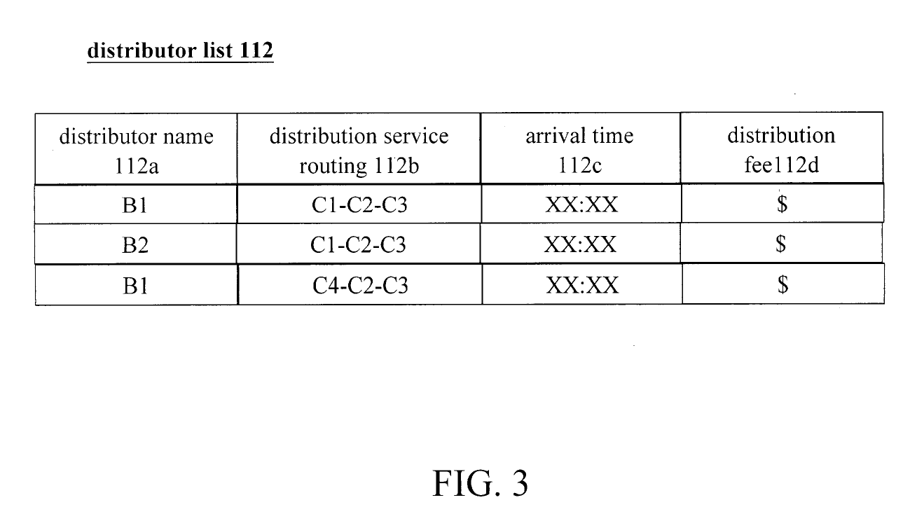

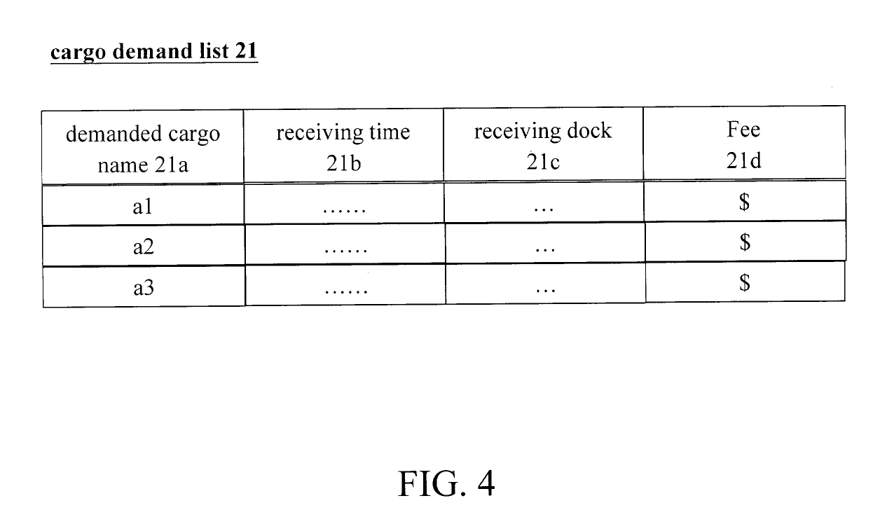

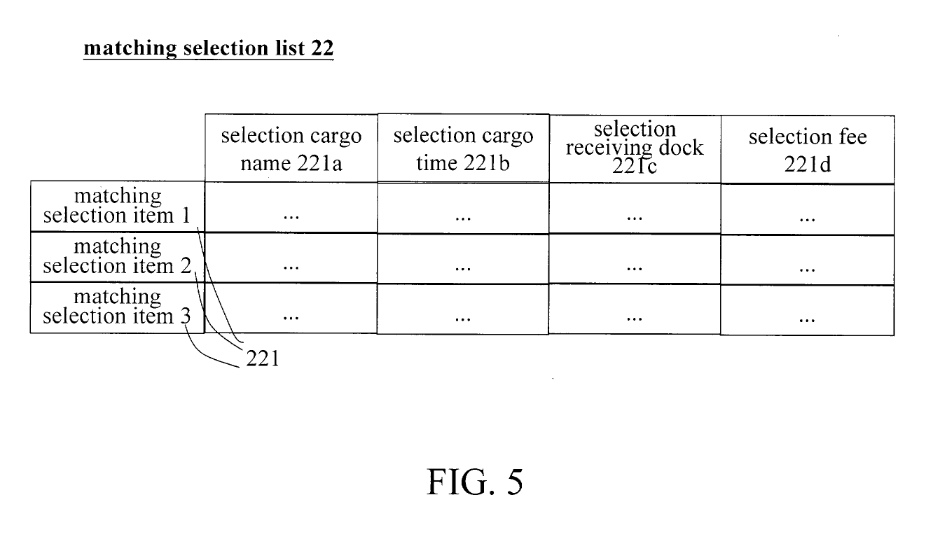

As illustrated in FIG. 1, FIG. 2, FIG. 3, FIG. 4 and FIG. 5, the planning system of cargo supply and transportation of the invention includes a server 10 and a client 20. The server 10 has a database 11 and a matching processor 12.

The database 11 has a supplier list 111 and a distributor list 112. The supplier list 111 has a supplier name 111a, a supplier address 111b, a cargo name 111c, and a cargo fee 111d. The supplier name 111a, the supplier address 111b, the cargo name 111c and the cargo fee are corresponding. In case the supplier name 111a provides the same cargo name 111c, the supplier name 111a is corresponding to the same cargo name 111c. In case the supplier name 111a provides the same cargo name 111c to a different supplier address 111b, the supplier name 111a corresponds to the same cargo name 111c and different supplier address 111b, etc.

The distributor list 112 has a distributor name 112a, a distribution service routing 112b, an arrival time 112c and a distribution fee 112d. The distributor name 112a, the distribution service routing 112b, the arrival time 112c, and distribution fee are correspondent. In case the distributor name 112a provides the same distribution service routing 112b, the distributor name 112a corresponds to the same distribution service routing 112b. The cargo arrives on a different arrival time 112c, the distributor name 112a has the same distribution service routing 112b. Therefore, the distributor name 112a does also correspond to the same distribution service routing 112b, different arrival time, etc.

The matching processor 12 is connected to the database 11.

The client 20 is optionally connected to the server 10 and transmits the cargo demand list 21 to the matching processor 12 of the server 10. The cargo demand list 21 has a cargo demanded name 21a, a receiving time 21b, a receiving dock 21c, and a fee 21d. After the matching processor 12 has received the cargo demand list 21, the matching processor 12 retrieves the supplier list 111 and the distributor list 112 from the database 11 and then matches the cargo demanded list 21, the supplier list 111, and the distributor list 112. The matching processor 12 transmits a matching selection list 22 to the client 20 for selecting and then transmits a selection item to the server 10 for assuring. The matching selection list 22 has multiple matching selection items 221 near to the cargo demanded list 21. The matching selection items 221 have a selection cargo name 221a, a selection receiving time 221b, a selection receiving dock 221c, and a selection fee 221d which correspond to each other.

Customers can input the related cargo demanded name 21a, the receiving time 21b, the receiving dock 21c and the fee 21d in the cargo demanded list 21 according to the invention when shopping on the Internet. Then the cargo demanded list 21 is delivered to the matching processor 21. The matching processor 21 then retrieves the supplier list 111 and the distributor list 112 such, that a matching selection list 22 with multiple matching selection items 221 close to the cargo demanded list 21 is provided and then transmitted to the client 20. The customer can select the desired matching selection items 221 according to the selection cargo name 221a, the selection receiving time 221b, the selection receiving dock 221c and the selection fee 221d in the selection items 221. The matching selection items 221 the customer chooses are then transmitted to the server 10 for assuring.

Moreover, in the matching selection item 221 (if the selection receiving time 221b, the selection receiving dock 221c are the same as a data stored in the database 11), the fee is calculated again because the distribution fee 112d is shared. When the consumer selects a specific distributor name 112a, the cargo demanded list 21 is transmitted with the specific distributor name 112a.

The planning system of cargo supply and transportation disclosed in the invention matches the service required by the consumer and the service provided by the server such that the server provides the service that meets the customer's need best. The consumer receives cargo at the desired place and on the desired time. Further, the distribution fee is shared by different customers who choose the same distribution routing. When the supplier is far away from the customer and no distributor provides the distribution service routing, the distribution service provided by different distributor is realized through the invention. Lower fee or the distributor selected by the customer is available when different distributors provide the same distribution routing.

Taking the described invention in mind, it will be obvious that the same may be varied in many ways. Such variations are not regarded as a departure from the spirit and scope of the invention, and all such modifications as would be obvious to one skilled in the art are included within the scope of the following claims.

What is claimed is:

1. A planning system of cargo supply and transportation comprising:
a server comprising:
a database which stores a supplier list and a distributor list, wherein the supplier list having multiple cargo names and cargo fees correspondent to the cargo names, the distributor list having multiple distribution service routings, and multiple arrival time and distribution fees correspondent to the distribution service routings; and
a matching processor connected with the database; and
a client, connected with the server optionally, and transmitting a cargo demand list to the matching processor of the server, wherein the cargo demand list having a cargo demanded name, a receiving time, a receiving dock, and a fee, after the matching processor receiving the cargo demand list, then retrieving the supplier list and the distributor list from the database to match the cargo demand list, the supplier list, and the distributor list, transmitting a matching selection list to the client for selecting and transmit a selection item to the server for assuring.

2. The planning system of claim 1, wherein the supplier list further comprises multiple supplier names correspondent to the cargo name and supplier addresses correspondent to the supplier.

3. The planning system of claim 1, wherein the distributor list further comprises multiple distribution names correspondent to the distribution service routings.

4. The planning system of claim 1, wherein the matching selection list further comprises matching selection items near to the cargo demand list.

5. The planning system of claim 4, wherein the matching selection items comprises a selection cargo name, a selection receiving time, a selection receiving dock and a selection fee correspondently.

6. The planning system of claim 1, wherein the database further stores a stored data for the matching processor.

7. The planning system of claim 1, wherein the cargo demand list further comprises a demanded distributor.
